(19) United States
(12) Patent Application Publication
(10) Pub. No.: US 2015/0174682 A1
(43) Pub. Date: Jun. 25, 2015

(54) WELDING WIRE CONVEYOR ROLLER AND FEEDING DEVICE FOR CONVEYING WELDING WIRE

(71) Applicant: Fronius International GmbH, Pettenbach (AT)

(72) Inventors: Alfred SPIESBERGER, Buchkirchen (AT); Maximilian ROLA, Wartberg an der Krems (AT)

(73) Assignee: FRONIUS INTERNATIONAL GMBH, Pettenbach (AT)

(21) Appl. No.: 14/578,782

(22) Filed: Dec. 22, 2014

(30) Foreign Application Priority Data
Dec. 23, 2013 (AT) A 50855/2013

(51) Int. Cl. B23K 9/133; B23K 9/12

(52) U.S. Cl. CPC B23K 9/1336; B23K 9/125

(57) ABSTRACT

A welding wire conveyor roller for conveying a welding wire includes a receiving aperture for receiving a receiving pin, and a running surface for the welding wire, and a feeding device for conveying a welding wire includes a drive motor, at least two receiving pins arranged at a distance to each other, and at least two welding wire conveyor rollers with running surfaces for the welding wire which are placed upon the receiving pins by appropriate receiving apertures. For achieving improved conveying properties even with different welding wires, an area elastically deformable in the radial direction is arranged between the running surface and the receiving aperture of the welding wire conveyor rollers.

### CROSS REFERENCE TO RELATED APPLICATIONS

Applicant claims priority under 35 U.S.C. §119 of Austrian Application No. A 50855/2013 filed Dec. 23, 2013, the disclosure of which is incorporated by reference.

### BACKGROUND OF THE INVENTION

1. Field of the Invention

The invention relates to a welding wire conveyor roller for conveying a welding wire, comprising a receiving aperture for receiving a receiving pin and a running surface for the welding wire, and to a feeding device for conveying a welding wire, comprising a drive motor, at least two receiving pins arranged at a distance to each other, and at least two welding wire conveyor rollers placed upon the receiving pins by appropriate receiving apertures and comprising running surfaces for the welding wire.

2. Description of the Related Art

Feeding devices for the conveying of welding wires comprise usually two conveyor rollers, one pressing roller and one counter roller between which the welding wire is clamped and moved to the desired place, for instance, the welding torch, on rotation of the welding wire conveyor rollers.

AT 229 673 B, for instance, describes a feeding device in which the welding wire is clamped and conveyed between two oppositely arranged conveyor rollers.

A feeding device comprising two pressure rollers and two counter rollers is described in DE 293 526 A5. This is to achieve increased contact pressure on the welding wire to be conveyed and improved continuous conveying.

With all such known devices, basically rigid welding wire conveyor rollers are used which are usually made of metal and comprise, for instance, a longitudinal groove for guiding the welding wire or are provided with a roughened surface or a coating so as to increase the friction between the welding wire and the conveyor rollers. For optimum conveying of the welding wire a particular contact pressure is required. In the case of the previous conveyor rollers the contact pressure on the welding wire is exerted in a very small area only, quasi in one point, which may result in deformation of the welding wire.

With different diameters of the welding wires it is necessary to use different welding wire conveyor rollers or to provide adjustment means to achieve optimum contact pressures and thus optimum conveying conditions.

### SUMMARY OF THE INVENTION

It is an object of the invention to provide an above-mentioned welding wire conveyor roller and a feeding device for conveying a welding wire by which it is possible to improve the conveying properties even with different welding wires, and with a simple construction at the same time.

The object according to the invention is solved by an above-mentioned welding wire conveyor roller in which an area elastically deformable in the radial direction is arranged between the running surface and the receiving aperture. By means of the welding wire conveyor rollers which are elastically deformable at least in an area it is possible to achieve optimum conveying properties since the welding wire is clamped across a larger area and since no punctual forces thus occur. By the fact that, due to the deformation, the welding wire conveyor rollers and/or their running surfaces snuggle better to the welding wire to be conveyed, an enlarged contact face is created between the welding wire conveyor roller and the welding wire, which results in a smaller surface pressure on the welding wire without the achievable conveying force on the welding wire being reduced thereby. Due to the smaller surface pressure the welding wire is treated gently, damage to its surface which has an adverse effect above all on the electrical contacting is prevented or strongly reduced, and the welding wire is saved from disadvantageous deformation. Furthermore, it is not necessary to newly set and adjust the contact pressure with every change of the welding wire. So far, it has been necessary to adjust the contact pressure of the conveyor rollers with every change of the welding wire so as to be able to clamp and/or convey the welding wire optimally. During this time it was not possible to use the welding plant productively. In the case of a manual adjustment of the contact pressure there is also the risk of misadjustment caused by a selection of the parameters which is not optimal. In the case of the welding wire conveyor roller according to the invention the contact pressure adjusts itself autonomouily to an optimum value within particular limits of the welding wire diameter. It is likewise of advantage that tolerance differences of the welding wire are compensated for.

The elastically deformable area of the welding wire conveyor rollers may be formed by recesses. These recesses and/or clearances in the welding wire conveyor rollers cause the desired deformation in the case of radial pressure load, by which it is possible to optimally clamp and convey the welding wire, depending on the diameter and on the consistency. Since two equal welding wire conveyor rollers are preferably used, the required share of deformation will be distributed equally to both welding wire conveyor rollers. The center of the welding wire will remain unchanged at the same position between the two welding wire conveyor rollers both when thin and when thick welding wires are used. This is of importance insofar as the welding wire may enter centrally in a following guide sleeve or the like without friction and without damage or deformation after leaving the pair of welding wire conveyor rollers.

As an alternative to the above-mentioned recesses and/or slots in the welding wire conveyor rollers, the elastically deformable area of the welding wire conveyor rollers may also be formed by spiral arms arranged to move between an outer ring forming the running surface and an inner ring forming the receiving aperture.

The receiving apertures of the welding wire conveyor rollers may be designed to taper, preferably to be cone-shaped.

For achieving particular characteristics of deformation in the area of the running surfaces of the welding wire conveyor rollers the running surface may comprise a surface pattern.

At least the elastically deformable area of the welding wire conveyor roller may consist of spring steel or else of a non-metal material, in particular a plastic material. Elastomers are particularly suited as plastic materials. In order to avoid a punctual pressing and/or cutting in of the welding wire on the running surface especially with these welding wire conveyor rollers which consist at least partially of an elastomer, the running surface of the welding wire conveyor roller may be bandaged with a resistant material, in particular spring steel.

The object according to the invention is also solved by a feeding device for conveying a welding wire, wherein at least one welding wire conveyor roller comprises an area elastically deformable in the radial direction between the running surface and the receiving aperture, and wherein the welding wire conveyor rollers are pressed against each other and/or against the welding wire by the receiving pins. Due to the at least one welding wire conveyor roller with the elastically deformable area it is possible to achieve optimum conveying properties since the welding wire can be clamped across a larger area and since hence no punctual forces occur. Likewise, it is possible to convey welding wires with different diameters or cross-sectional shapes with this feeding device without manual adjustments being necessary and waiting times for adjustment or change of the welding wire conveyor rolls occurring. The omission of a changing process of the welding wire conveyor rollers as well as of a manual adjustment of the optimum pressure is altogether a substantial simplification and a considerable saving in time. Further advantages may be taken from the above description of the welding wire conveyor rollers.

As already mentioned above with the welding wire conveyor rollers, the elastically deformable area of at least one welding wire conveyor roller may be formed by recesses and/or slots or by spiral arms arranged to move between an outer ring forming the running surface and an inner ring forming the receiving aperture.

The receiving apertures of the welding wire conveyor rollers may be designed to taper, preferably to be cone-shaped.

Advantageously, the receiving pins are, in correspondence with the design of the receiving apertures of the welding wire conveyor rollers, designed to taper to the free ends thereof, preferably to be cone-shaped. This makes it easy to slip on and press the welding wire conveyor rollers against each other.

As already mentioned above, the running surface of at least one welding wire conveyor roller may comprise a surface pattern.

At least the elastically deformable area of the welding wire conveyor rollers may consist of spring steel or else of a non-metal material, in particular of a plastic material.

The distance of the receiving pins relative to each other is preferably fixed. For an optimum adaptation of the contact pressure on the welding wire it is of advantage if the welding wire conveyor rollers mounted in the feeding device comprise a deformation even if no welding wire is arranged between them. This is achieved in that the sum of the radii of the unloaded welding wire conveyor rollers is larger than the center distance of the receiving pins.

### BRIEF DESCRIPTION OF THE DRAWINGS

The invention will be explained in more detail by means of the embodiments illustrated in the enclosed drawings. These show:

FIG. 1 shows the feeding device with welding wire conveyor rollers according to a first embodiment variant;

FIG. 2 shows the feeding device according to FIG. 1 in side view;

FIG. 3 shows the feeding device according to FIG. 1 in plan view;

FIG. 4 shows the feeding device according to FIG. 1 with the welding wire conveyor rollers in a partially sectional illustration in front view;

FIGS. 5a and 5b show an embodiment of a welding wire conveyor roller with recesses in oblique view from the front and rear sides;

FIG. 6 shows another embodiment of a welding wire conveyor roller with spiral arms in oblique view; and

FIG. 7 shows another embodiment of a welding wire conveyor roller with spiral arms in oblique view.

### DETAILED DESCRIPTION OF PREFERRED EMBODIMENTS

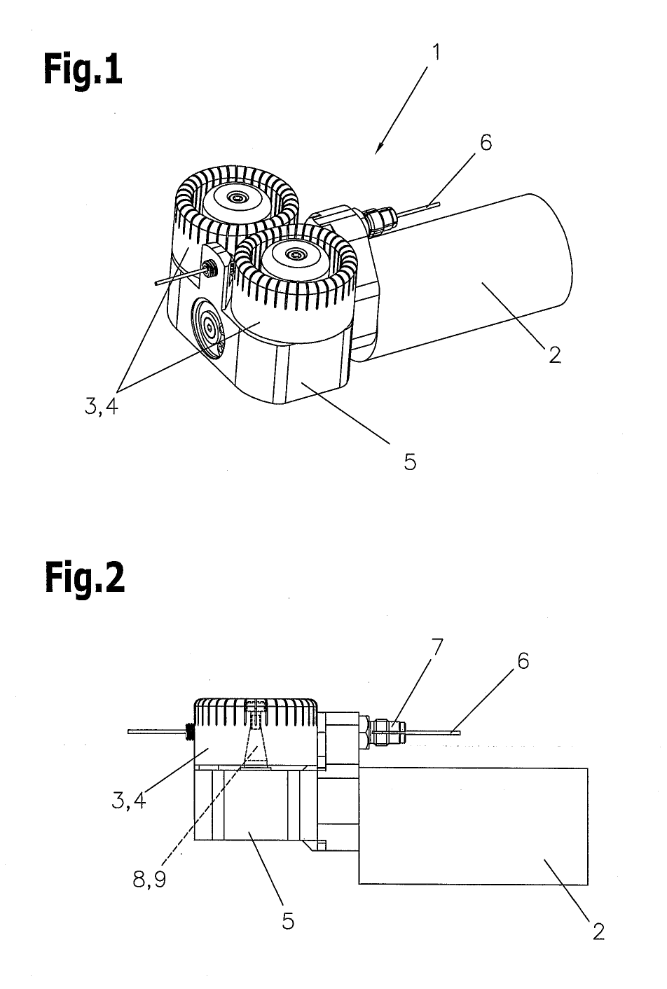

FIG. 1 illustrates a feeding device 1 with a drive motor 2 and a gear 5 connected thereto and an embodiment of the welding wire conveyor rollers 3, 4 in accordance with the invention for conveying the welding wire 6. By means of the welding wire conveyor rollers 3, 4 according to the invention complete clamping of the welding wire 6 to be conveyed is achieved. An adjustment means for adapting the feeding device 1 to the welding wire 6 is not required due to the elasticity of the welding wire conveyor rollers 3, 4 in accordance with the invention.

FIG. 2 illustrates the feeding device 1 of FIG. 1 in side view for a clearer illustration of the guiding of the welding wire 6 through the guiding sleeve 7 and the welding wire conveyor rollers 3, 4. The drive motor 2 drives the gear 5 which in turn rotates at least one of the receiving pins 8, 9 on which the welding wire conveyor rollers 3, 4 are mounted. The gear 5 is designed such that at least one of the receiving pins 8, 9 is driven. Since, with the feeding device 1 according to the invention, both welding wire conveyor rollers 3, 4 or receiving pins 8, 9, respectively, are mounted at a fixed distance b to each other (see FIG. 4), any components of the gear 5 which are required for the drive may be fixed and arranged in a closed system. Accordingly, the drive and/or the gear 5 require less maintenance.

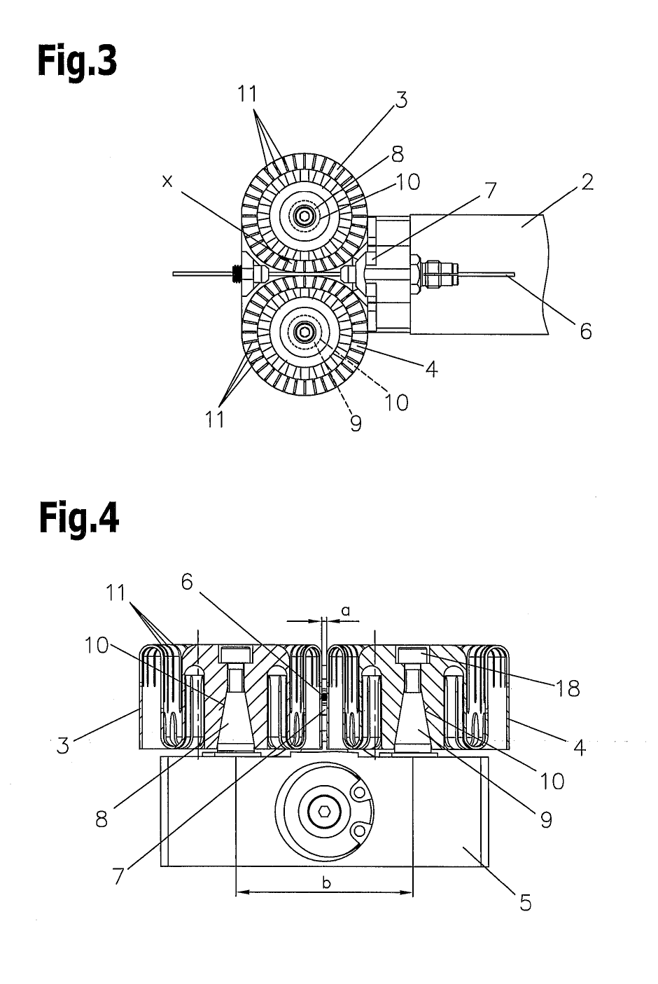

FIG. 3 illustrates the feeding device 1 pursuant to FIGS. 1 and 2 in plan view, so that the guiding sleeve 7 which is positioned upstream of the welding wire conveyor rollers 3, 4 and which ensures the correct entry of the welding wire 6 can be seen. Through the guiding sleeve 7 the welding wire 6 is thus supplied to the welding wire conveyor rollers 3, 4 in those places in which optimum conveying can be achieved. The welding wire 6 may vary in shape and diameter. Usually, the welding wire 6 is designed to be substantially round, but it may, for instance, also be designed as a flat wire with a rectangular cross-section. With the welding wire conveyor rollers 3, 4 according to the invention its is basically possible to convey welding wires 6 with any cross-sections that are presently known.

The welding wire conveyor rollers 3, 4 are designed such that clamping of the welding wire 6 is performed with simultaneous deformation of the welding wire conveyor rollers 3, 4. The clamping is not, as with usual systems, achieved by a manual adjustment unit, but by the welding wire conveyor rollers 3, 4 comprising recesses 11 permitting a deformation in the case of pressure load and thus generating a clamping effect on the welding wire 6. This deformation may be seen in the area marked with “X” in FIG. 3. It can be recognized that the welding wire conveyor rollers 3, 4 are not designed to be uniformly round in this area X, but that a deformation appears which finally enables the clamping across a larger area for conveying the welding wire 6. Clamping and deformation of the welding wire conveyor rollers 3, 4 are enabled by the cone-shaped receiving aperture 10 of the welding wire conveyor rollers 3, 4 and the correspondingly cone-shaped receiving pins 8, 9 on the gear 5. When the welding wire conveyor rollers 3, 4 are placed upon the receiving pins 8, 9, the conveyor rollers 3, 4 are forcibly pressed against each other toward the center and/or the longitudinal axis of the welding wire 6. Thus, the welding wire conveyor rollers 3, 4 are pressed against each other and/or against the welding wire 6 by the receiving pins 8, 9. An elastically deformable area which is autonomously reversible, i.e. strives to return to the original shape, is positioned between the running surface 12 and the receiving aperture 10 of at least one welding wire conveyor roller 3, 4.

FIG. 4 illustrates an embodiment of the welding wire conveyor rollers 3, 4 in a partially sectional shape and the welding wire 6 to be conveyed and the receiving pins 8, 9 in front view. The guiding sleeve 7 for guiding the welding wire 6 between the welding wire conveyor rollers 3, 4 to the position provided for optimum clamping may also be seen. The welding wire 6 is inserted between the welding wire conveyor rollers 3, 4 in the area in which optimum friction by deformation can be produced. This is substantially the case in the center. The cone-shaped receiving pins 8, 9 which are rotated by the gear 5 or the drive motor 2, respectively, may also be seen well. Instead of a cone-shaped receiving pin 8, 9 and a cone-shaped receiving aperture 10, a design in the form of a pyramidal square is also possible. Likewise, key slots may be arranged at the cone through which the torque is transmitted. The torque required for conveying the welding wire 6 may be transmitted in a non-positive or else in a positive manner. In the illustrated embodiment transmission is performed in a non-positive manner. The tapering shape of the receiving pins 8, 9 makes it possible to bias the welding wire conveyor rollers 3, 4 appropriately during assembly.

The welding wire conveyor rollers 3, 4 are placed upon the receiving cones 8, 9 with the appropriately designed receiving aperture 10 and are, for instance, fixed with a screw 18. In joint view with FIG. 3, the partial deformation of the welding wire conveyor rollers 3, 4 can also be seen here, which results from the fact that the clamped welding wire 6 creates a counter pressure which in turn results in the recesses 11 and/or slots of the welding wire conveyor rollers 3, 4 narrowing with respect to each other, i.e. the distance between the running surface 12 and the receiving aperture 10 of the welding wire conveyor roller 3, 4 is reduced.

The welding wire 6 is thus conveyed through the guiding sleeve 7 between the welding wire conveyor rollers 3, 4 and clamped two-dimensionally with a particular force. As soon as the welding wire conveyor rollers 3, 4 are rotated, the welding wire 6 is conveyed. The clamping of the welding wire 6 which is caused by the deformation of the welding wire conveyor rollers 3, 4 increases the friction so as to continuously convey the welding wire 6. The optimum clamping of a welding wire 6, for instance, of a diameter of 0.8 mm is achieved in that the welding wire conveyor rollers 3, 4 comprise a defined center distance b. The center distance b of the axes of the welding wire conveyor rollers 3, 4 is fixedly defined and invariable in contrast to known systems. An adjustment of the center distance b is, in contrast to the previously used feeding devices 1 for welding wires 6, not given and/or not necessary.

If welding wires 6 of a larger diameter are conveyed with the welding wire conveyor rollers 3, 4 according to the invention, larger deformation of the welding wire conveyor rollers 3, 4 and higher contact pressure on the welding wire 6 will ensue. If, for instance, a welding wire 6 with a diameter of 1.2 mm is used, this welding wire 6 will be clamped with larger force as compared to a welding wire 6 of 0.8 mm since the deformable welding wire conveyor rollers 3, 4 are deformed to a higher degree. Correspondingly, the area across which the clamping of the welding wire 6 occurs will also increase. Depending on the shape and the diameter of the welding wire 6 the clamping force will quasi be adapted “automatically”. At any rate, the original distance a, i.e. before the welding wire 6 is positioned between the welding wire conveyor rollers 3, 4, must be smaller than the diameter of the smallest welding wire 6 used, since the effect according to the invention cannot be implemented otherwise. The distance a results from the center distance b and the diameter of the conveyor rollers 3, 4.

Even if no welding wire 6 is positioned between the welding wire conveyor rollers 3, 4, a deformation of the welding wire conveyor rollers 3, 4 already takes place in the area X (see FIG. 3) since the welding wire conveyor rollers 3, 4 are in contact with each other in the area X because the center distance b is smaller than twice the radius or the diameter, respectively, of the welding wire conveyor rollers 3, 4. As soon as a welding wire 6 is guided between the welding wire conveyor rollers 3, 4, a distance a corresponding substantially to the diameter and/or the thickness of the welding wire 6 a will automatically adjust itself. The respective pressure conditions with respect to the welding wire 6 may be influenced by the distance a.

Obviously, however, the distance a should be slightly smaller than the diameter of the smallest welding wire 6 used since at least a small bias and a contact pressure are required. If the diameter of the welding wire 6 were equal to the distance a, no contact pressure theoretically exists and the welding wire 6 cannot be conveyed.

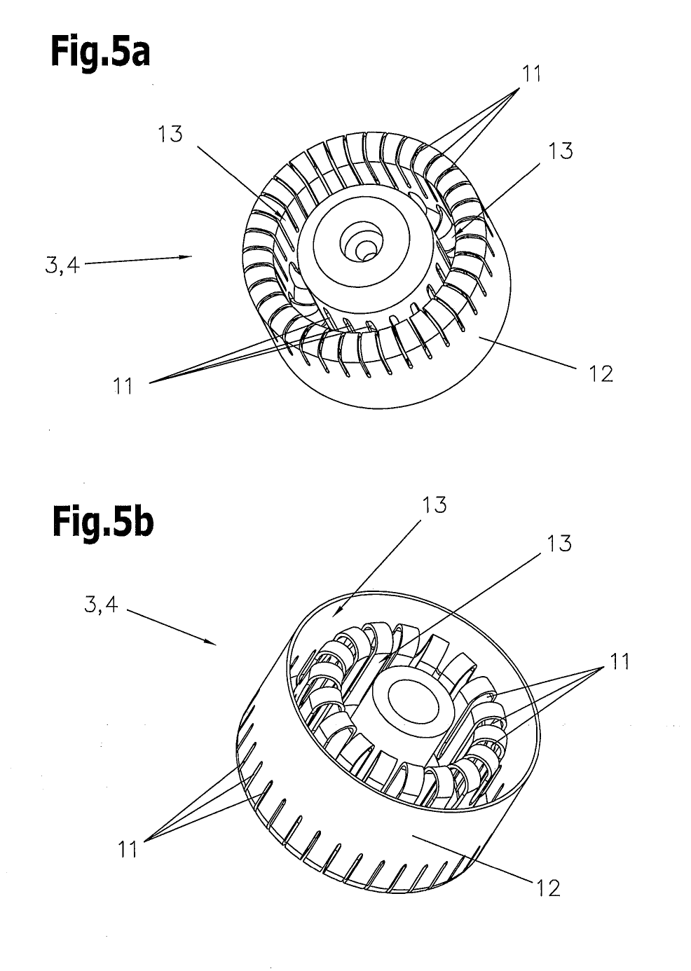

In the following, variants of the structure of the welding wire conveyor rollers 3, 4 will be described by way of example. Thus, FIGS. 5a and 5b illustrate an embodiment of the welding wire conveyor roller 3, 4, for instance, of spring steel. The welding wire conveyor rollers 3, 4 are constructed to be deformable and to have a quasi completely elastic behavior, i.e. strive to reassume the original shape, so that the abovedescribed effect can be implemented. The welding wire conveyor rollers 3, 4 are constructed to be of one piece and of homogeneous material. Deformability is achieved in that the welding wire conveyor rollers 3, 4 comprise radially circumferential recesses 11 and/or slots viewed from the top. The recesses 11 are distributed circumferentially at regular angular distances to each other and extend from one portion of the running surface 12 over the appropriately shaped welding wire conveyor rollers 3, 4 and thus implement a functionally effective deformation of the running surface 12. To enable the deformation of the running surface 12 and/or of the welding wire conveyor rollers 3, 4, the clearances formed by the recesses 11 have to exist which are reduced in the case of pressure load and permit a deformation to an effective degree. However, in order to ensure the strength of the welding wire conveyor rollers 3, 4, the recesses 11 may only reach down to a particular depth, for instance, two thirds of the height of the running surface 12.

In the welding wire conveyor rollers 3, 4, depressions 13 may be arranged on both sides, i.e. at the front side and at the rear side, said depressions 13 also being crossed with the recesses 11, so that an appropriate deformation becomes possible in the case of radial pressure load.

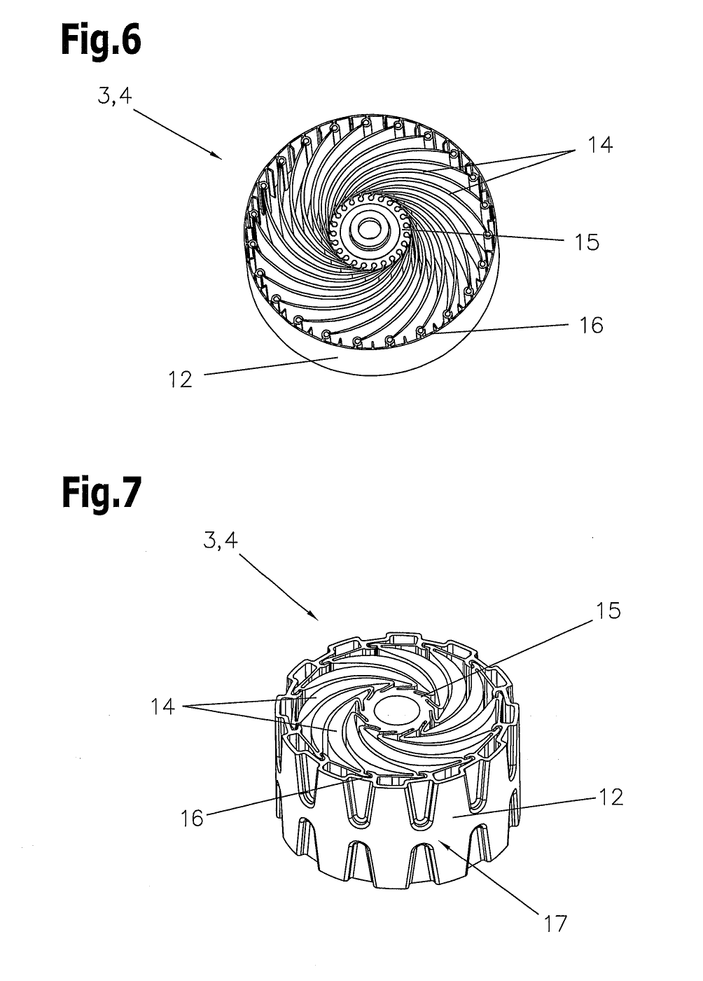

The embodiment variant of the welding wire conveyor roller 3, 4 pursuant to FIG. 6 consists of circumferential spiral arms 14. The spiral arms 14 are hooked in an inner ring 15 and extend from the inner ring 15 in an arc shape to an outer ring 16 where they are again hooked. The running surface 12 is positioned at the outer side of the outer ring 16. The clearances generated between the spiral arms 14 enable the deformation of the pressure roller 3, 4 in the case of radial pressure load on the outer ring 16. Thus, as soon as a welding wire 6 of any diameter is introduced between the welding wire conveyor rollers 3, 4, the outer ring 16 will deform by the spiral arms 14 by the pressure load occurring thereby. The pressure on the welding wire 6 is automatically adapted to the diameter thereof. The number, shape, thickness, and elasticity of the spiral arms 14 may be different. The spiral arms 14 may be made of a metal material or a non-metal material such as a plastic material.

FIG. 7 illustrates a variant of the welding wire conveyor roller 3, 4 with spiral arms 14 whose number is reduced as compared to the embodiment pursuant to FIG. 6 and whose thickness is increased as compared to the variant pursuant to FIG. 6.

With all welding wire conveyor rollers 3, 4 the running surface 12 which is in direct contact with the welding wire 6 may be of different design, for instance, smooth or with a particular surface pattern 17, as may be seen from FIG. 7. Such a surface pattern 17 makes it possible to achieve an optimum deformation behavior and an optimum transmission of force. The surface pattern 17 may, for instance, comprise ridges and depressions pursuant to FIG. 7, so that deformability but also the required strength and/or stiffness are ensured.

Depending on the welding wire 6 used (e.g. aluminum welding wire or steel welding wire), the welding wire conveyor rollers 3, 4 according to the invention may consist of different materials. The dimensions and diameters of the welding wire conveyor rollers 3, 4 may also vary so as to fulfil the different requirements with respect to friction and pressure. Thus, an aluminum welding wire may be operated with another diameter of the welding wire conveyor rollers 3, 4 according to the invention than welding wire conveyor rollers 3, 4 for a steel welding wire. In this respect, the distance a may also vary. All embodiments have in common that an elastically deformable area is positioned between the running surface 12 of the welding wire conveyor rollers 3, 4 and the preferably cone-shaped receiving pins 8, 9 and/or the cone-shaped receiving apertures 10 of the welding wire conveyor rollers 3, 4, said elastically deformable area being, for instance, formed by the recesses 11 and/or slots described and ensuring the deformability of the welding wire conveyor rollers 3, 4.

What is claimed is:

1. A welding wire conveyor roller (3, 4) for conveying a welding wire (6), comprising a receiving aperture (10) for receiving a receiving pin (8, 9) and a running surface (12) for the welding wire (6), wherein an area elastically deformable in the radial direction is arranged between the running surface (12) and the receiving aperture (10).

2. The welding wire conveyor roller (3, 4) according to claim 1, wherein the elastically deformable area is formed by recesses (11).

3. The welding wire conveyor roller (3, 4) according to claim 1, wherein the elastically deformable area is formed by spiral arms (14) arranged to move between an outer ring (16) forming the running surface (12) and an inner ring (15) forming the receiving aperture (10).

4. The welding wire conveyor roller (3, 4) according to claim 1, wherein the receiving apertures (10) are designed to taper, preferably to be cone-shaped.

5. The welding wire conveyor roller (3, 4) according to claim 1, wherein the running surface (12) comprises a surface pattern (17).

6. The welding wire conveyor roller (3, 4) according to claim 1, wherein at least the elastically deformable area comprises spring steel.

7. The welding wire conveyor roller (3, 4) according to claim 1, wherein at least the elastically deformable area comprises a non-metal material, in particular a plastic material.

8. A feeding device (1) for conveying a welding wire (6), comprising a drive motor (2), at least two receiving pins (8, 9) arranged at a distance to each other, and at least two welding wire conveyor rollers (3, 4) with running surfaces (12) for the welding wire (6) which are placed upon the receiving pins (8, 9) by appropriate receiving apertures (10), wherein at least one welding wire conveyor roller (3, 4) comprises an area elastically deformable in the radial direction between the running surface (12) and the receiving aperture (10), and wherein the welding wire conveyor rollers (3, 4) are pressed against each other by the receiving pins (8, 9).

9. The feeding device (1) according to claim 8, wherein the elastically deformable area of at least one welding wire conveyor roller (3, 4) is formed by recesses (11).

10. The feeding device (1) according to claim 8, wherein the elastically deformable area of at least one welding wire conveyor roller (3, 4) is formed by spiral arms (14) arranged to move between an outer ring (16) forming the running surface (12) and an inner ring (15) forming the receiving aperture (10).

11. The feeding device (1) according to claim 8, wherein the receiving apertures (10) of the welding wire conveyor rollers (3, 4) are designed to taper, preferably to be cone-shaped.

12. The feeding device (1) according to claim 11, wherein the receiving pins (8, 9) are designed in correspondence with the design of the receiving apertures (10) of the welding wire conveyor rollers (3, 4) to taper to the free ends thereof, preferably to be cone-shaped.

13. The feeding device (1) according to claim 8, wherein the running surface (12) of at least one welding wire conveyor roller (3, 4) comprises a surface pattern (17).

14. The feeding device (1) according to claim 8, wherein at least the elastically deformable area of the welding wire conveyor rollers (3, 4) comprises spring steel.

15. The feeding device (1) according to claim 8, wherein at least the elastically deformable area of the welding wire conveyor rollers (3, 4) comprises a non-metal material, in particular of a plastic material.

16. The feeding device (1) according to claim 8, wherein the distance (b) of the receiving pins (8, 9) with respect to each other is fixed.
